(19) United States
(12) Patent Application Publication
(10) Pub. No.: US 2024/0419003 A1
(43) Pub. Date: Dec. 19, 2024

(54) AR GLASSES

(71) Applicant: FALCON INNOVATIONS TECHNOLOGY (SHENZHEN) CO., LTD., Shenzhen, Guangdong (CN)

(72) Inventors: Zhiwen SUN, Shenzhen, Guangdong (CN); Junjie ZHANG, Shenzhen, Guangdong (CN); Hongwei LI, Shenzhen, Guangdong (CN)

(73) Assignee: FALCON INNOVATIONS TECHNOLOGY (SHENZHEN) CO., LTD., Shenzhen, Guangdong (CN)

(21) Appl. No.: 18/700,806

(22) PCT Filed: Oct. 9, 2022
(86) PCT No.: PCT/CN2022/124154

§ 371 Date: Apr. 12, 2024

(30) Foreign Application Priority Data
Oct. 14, 2021 (CN) 202111200218.8
Oct. 14, 2021 (CN) 202122481212.4

(51) Int. Cl. G02B 27/01; G06T 19/00

(52) U.S. Cl. CPC G02B 27/0176; G06T 19/006; G02B 2027/0178

(57) ABSTRACT

AR glasses includes a display device, a color combination device (20), a projection lens (50), and a waveguide element (60). The display device includes multiple display screens. The display screens are respectively arranged around the color combination device (20). The color combination device (20) can be used for fusing the monochromatic colors emitted by the display screens to form an image. Light that constitutes the image enters user's eyes after being transmitted through the projection lens (50) and the waveguide element (60). The AR glasses have a compact structure and light weight to be worn for a long time.

This application claims the priority of Chinese Patent Application No. 202122481212.4, entitled “AR GLASSES”, filed on Oct. 14, 2021 in the China National Intellectual Property Administration (CNIPA), the content of which is incorporated herein by reference in its entirety.

### TECHNICAL FIELD

The present disclosure relates to a display technology field, and more particularly to AR glasses.

### BACKGROUND ART

AR glasses are a new type of glasses for an augmented reality (Augmented Reality) application. The Most AR glasses have diverse functions such as display, photography, video calling, text message processing, email, and game entertainment. The AR glasses can display virtual scenes in addition to real scenes. Users can even interact with virtual scenes. They are a new form of future smart hardware products.

### SUMMARY OF DISCLOSURE

### Technical Problem

However, most of the current AR glasses are large in size and overweight. Not only do they appear bulky in appearance, but they also feel very uncomfortable when worn for a long time, resulting in a poor user experience.

### Solution of Problem

### Technical Solution

Embodiments of the present application provide AR glasses, which are compact in structure, light in weight, can be worn for a long time, and have a good user experience.

An embodiment of the present disclosure provides AR glasses, including:
a display device, the display device including multiple display screens, and the display screens used for emitting multiple different monochromatic colors;
a color combination device, the display screens respectively arranged around the color combination device, and the color combination device used for fusing the monochromatic colors emitted by the display screens to form an image;
a projection lens, disposed on one side of a light exit side of the color combination device; and
a waveguide element, disposed on one side of the projection lens away from the color combination device.

### Advantageous Effects of Disclosure

### Advantageous Effects

The AR glasses provided by the embodiments of the present disclosure include a display device, a color combination device, a projection lens, and a waveguide element. The display device includes a plurality of display screens. The multiple display screens are respectively arranged around the color combination device. The color combination device can fuse the monochromatic colors emitted by multiple display screens together to form an image. The light that constitutes the image enters the user's eyes after being transmitted through the projection lens and waveguide components. The AR glasses have a compact structure and light weight. It can be worn for a long time, giving users a better experience.

### BRIEF DESCRIPTION OF DRAWINGS

### Description of Drawings

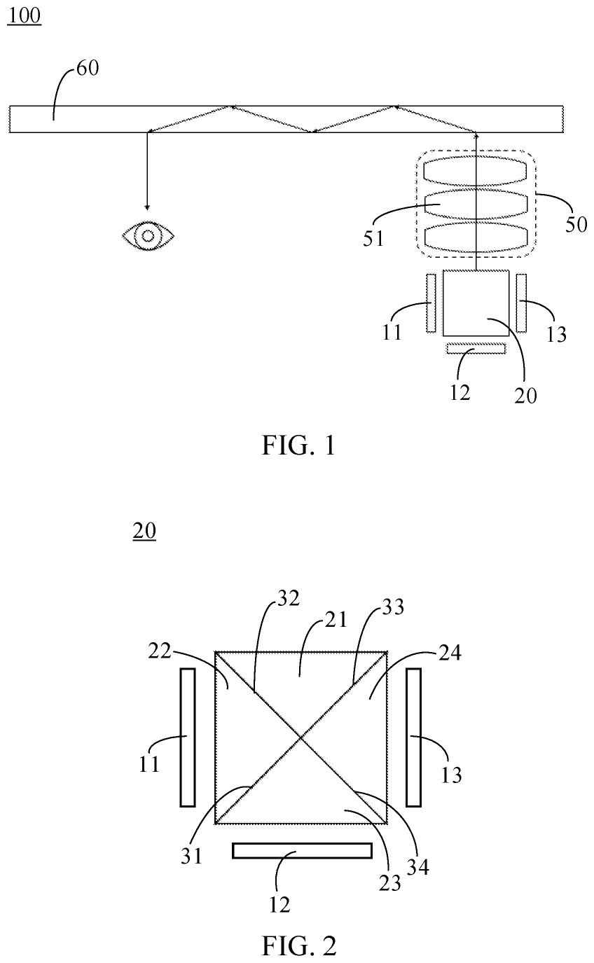

FIG. 1 illustrates a first structural schematic diagram of AR glasses provided by an embodiment of the present disclosure.

FIG. 2 illustrates a first structural schematic diagram of a color combination device provided by an embodiment of the present disclosure.

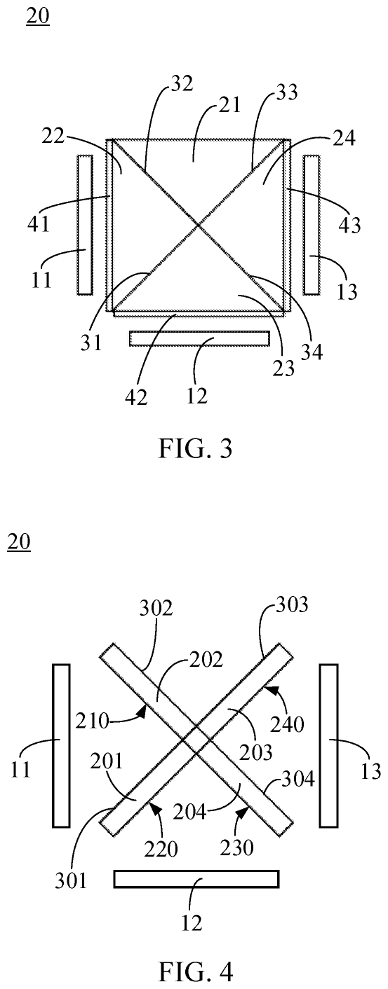

FIG. 3 illustrates a second structural schematic diagram of a color combination device provided by an embodiment of the present disclosure.

FIG. 4 illustrates a third structural schematic diagram of a color combination device provided by an embodiment of the present disclosure.

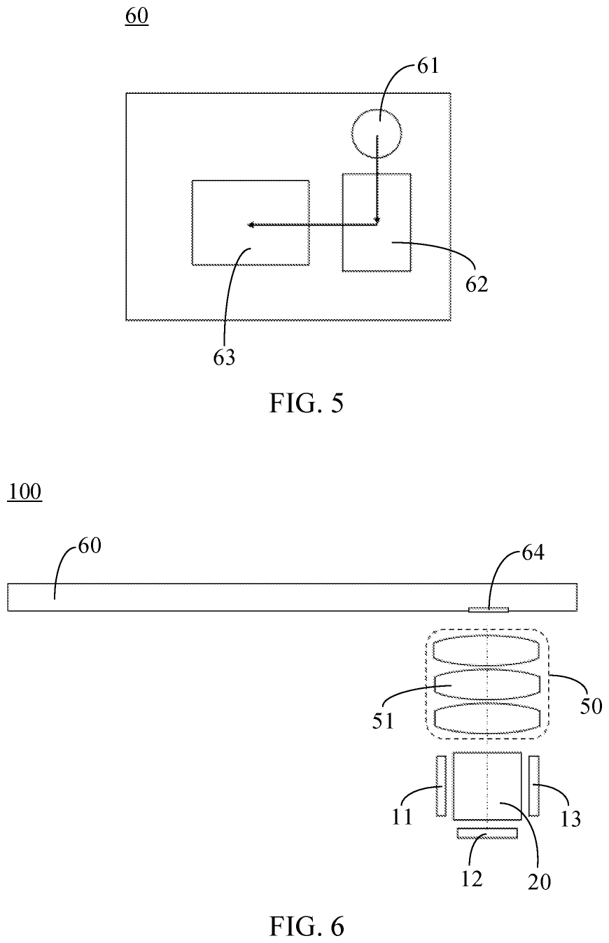

FIG. 5 is a schematic structural diagram of a waveguide element provided by an embodiment of the present disclosure.

FIG. 6 is a second structural schematic diagram of AR glasses provided by an embodiment of the present disclosure.

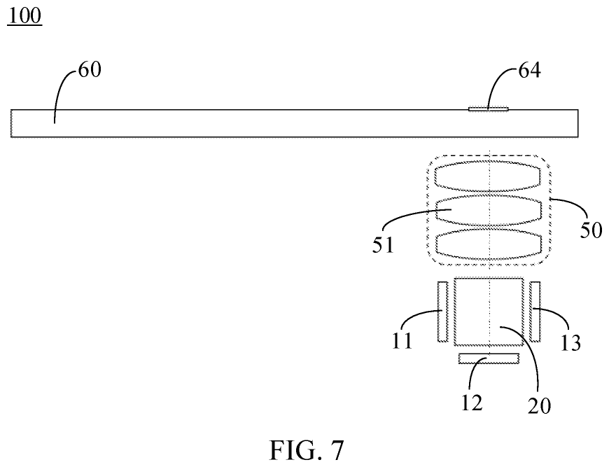

FIG. 7 is a third structural schematic diagram of AR glasses provided by an embodiment of the present disclosure.

### DISCLOSED EMBODIMENTS

### Embodiments of Present Disclosure

To make the objectives, technical solutions, and advantages of the present disclosure clearer and more comprehensible, the following further describes the present disclosure in detail with reference to the accompanying drawings and embodiments. It should be understood that the specific embodiments described herein are merely used to explain the present disclosure but are not intended to limit the present disclosure.

Please refer to FIG. 1. FIG. 1 illustrates a first structural schematic diagram of AR glasses provided by an embodiment of the present disclosure. An embodiment of the present disclosure provides AR glasses 100 which includes a display device, a color combination device 20, a projection lens 50, and a waveguide element 60. The display device includes multiple display screens. The display screens are used for emitting multiple different monochromatic colors. The display screens are respectively arranged around the color combination device 20. The color combination device 20 is used for fusing the monochromatic colors emitted by the display screens to form an image. The projection lens 50 is disposed on one side of a light exit side of the color combination device 20. The waveguide element 60 is disposed on one side of the projection lens 50 away from the color combination device 20.

It should be noted that besides the display device, the color combination device 20, the projection lens 50 and the waveguide element 60, the AR glasses 100 provided by the embodiment of the present disclosure can further include a lens part, a frame part, and a temple part (FIG. 1 is not shown). The lens part is installed on the frame part. The frame part is connected to the temple part. The lens part can contain one or more lenses. For example, the lens part can be a complete lens or two lenses corresponding to both eyes. The frame part can include nose braces. The frame part and the temple part as a whole can stabilize the AR glasses 100 on the user's eyes. The waveguide element 60 can be disposed on the lens part. The display device, the color combination device 20, and the projection lens 50 can be disposed on a position of the temples or a position of the frame.

For example, the AR glasses 100 can include two lenses, nose braces, and two temples. The nose braces are arranged between the two lenses and connects the two lenses. The two temples are respectively disposed on one side of the two lenses away from the nose braces. The waveguide element 60 can be disposed at the positions of the lenses. The display device, the color combination device 20, and the projection lens 50 can be disposed at the position of the temples or the nose braces.

Please refer to FIG. 1. The display device can include a first display screen 11, a second display screen 12, and a third display screen 13. The first display screen 11 is used for emitting a first monochromatic color, the second display screen 12 is used for emitting a second monochromatic color, and the third display screen 13 is used for emitting a third monochromatic color.

For example, the first display screen 11, the second display screen 12, and the third display screen 13 are all Micro LED display screens.

For example, the first monochromatic color, the second monochromatic color, and the third monochromatic color can be any combination of red light, green light, and blue light. That is, when one of the first monochromatic color, the second monochromatic color, and the third monochromatic color is red light, the other two colors are green light and blue light respectively.

Please refer to FIG. 2. FIG. 2 illustrates a first structural schematic diagram of a color combination device provided by an embodiment of the present disclosure. The color combination device 20 can include a first prism 21, a second prism 22, a third prism 23, and a fourth prism 24. The first prism 21, the second prism 22, the third prism 23, and the fourth prism 24 are all isosceles right-angle prisms.

Vertices of the first prism 21, the second prism 22, the third prism 23, and the fourth prism 24 are connected together. A bottom surface of the first prism 21 is a light exit surface of the color combination device 20. A bottom surface of the second prism 22 is disposed toward the first display screen 11. A bottom surface of the third prism 23 is disposed toward the second display screen 12. A bottom surface of the fourth prism 24 is disposed toward the third display screen 13.

A first optical film layer 31 is disposed between the third prism 23 and the second prism 22. The first optical film layer 31 is used for reflecting the first monochromatic color emitted by the first display screen 11 and transmitting the second monochromatic color emitted by the second display screen 12.

A second optical film layer 32 is disposed between the second prism 22 and the first prism 21. The second optical film layer 32 is used for reflecting the third monochromatic color emitted by the third display screen 13 and transmitting the first monochromatic color emitted by the first display screen 11 and the second monochromatic color emitted by the second display screen 12.

A third optical film layer 33 is disposed between the first prism 21 and the fourth prism 24. The third optical film layer 33 is used for reflecting the first monochromatic color emitted by the first display screen 11 and transmitting the second monochromatic color emitted by the second display screen 12 and the third monochromatic color emitted by the third display screen 13.

A fourth optical film layer 34 is disposed between the fourth prism 24 and the third prism 23. The fourth optical film layer 34 is used for reflecting the third monochromatic color emitted by the third display screen 13 and transmitting the second monochromatic color emitted by the second display screen 12.

It should be noted that the vertices of the first prism 21, the second prism 22, the third prism 23, and the fourth prism 24 respectively refer to the vertices of the right angles in cross-section isosceles right triangles of first prism 21, the second prism 22, the third prism 23, and the fourth prism 24. The bottom surface of the first prism 21, the bottom surface of the second prism 22, the bottom surface of the third prism 23, and the bottom surface of the fourth prism 24 respectively refer to the bottom surfaces in the cross-section isosceles right triangles of first prism 21, the second prism 22, the third prism 23, and the fourth prism 24.

For example, the first prism 21, the second prism 22, the third prism 2, and the fourth prism 24 are four identical isosceles right-angled prisms.

For example, a reflectivity of the first optical film layer 31 to the first monochromatic color is greater than a transmittance of the first optical film layer 31 to the first monochromatic color. A transmittance of the first optical film layer 31 to the second monochromatic color is greater than a transmittance of the first optical film layer 31 to the second monochromatic color.

A reflectivity of the second optical film layer 32 to the third monochromatic color is greater than a transmittance of the second optical film layer 32 to the third monochromatic color. A transmittance of the second optical film layer 32 to the first monochromatic color is greater than a reflectivity of the second optical film layer 32 to the first monochromatic color. A transmittance of the second optical film layer 32 to the second monochromatic color is greater than a reflectivity of the second optical film layer 32 to the second monochromatic color.

A reflectivity of the third optical film layer 33 to the first monochromatic color is greater than a transmittance of the third optical film layer 33 to the first monochromatic color. A transmittance of the third optical film layer 33 to the second monochromatic color is greater than a reflectivity of the third optical film layer 33 to the second monochromatic color. A transmittance of the third optical film layer 33 to the third monochromatic color is greater than a reflectivity of the third optical film layer 33 to the third monochromatic color.

A reflectivity of the fourth optical film layer 34 to the third monochromatic color is greater than a transmittance of the fourth optical film layer 34 to the third monochromatic color, and a transmittance of the fourth optical film layer 34 to the second monochromatic color is greater than a transmittance of the fourth optical film layer 34 to the second monochromatic color.

Please refer to FIG. 3. FIG. 3 illustrates a second structural schematic diagram of a color combination device provided by an embodiment of the present disclosure. A first anti-reflection film 41 can be provided on the bottom surface of the second prism 22, and the first anti-reflection film 41 is used for increasing the transmittance of the first monochromatic color.

A second anti-reflection film 42 can be provided on the bottom surface of the third prism 23, and the second anti-reflection film 42 is used for increasing the transmittance of the second monochromatic color.

A third anti-reflection film 43 can be provided on the bottom surface of the fourth prism 24, and the third anti-reflection film 43 is used for increasing the transmittance of the third monochromatic color.

A fourth anti-reflection film can be provided on the bottom surface of the first prism 21, and the fourth anti-reflection film is used for simultaneously increasing the transmittances of the first monochromatic color, the second monochromatic color, and the third monochromatic color.

It can be understood that functions of the first anti-reflection film 41, the second anti-reflection film 42, the third anti-reflection film 43, and the fourth anti-reflection film are to reduce the reflected light on the prism surface, thereby increasing the light transmission amount of the prism.

Please refer to FIG. 4. FIG. 4 illustrates a third structural schematic diagram of a color combination device provided by an embodiment of the present disclosure. The color combination device 20 can include a first plane mirror 210, a second plane mirror 220, a third plane mirror 230, and a fourth plane mirror 240. One end of the first plane mirror 210, one end of the second plane mirror 220, one end of the third plane mirror 230, and one end of the fourth plane mirror are connected together.

One side of the first plane mirror 210 and one side of the second plane mirror 220 are disposed toward the first display screen 11. One side of the second plane mirror 220 away from the first plane mirror 210 and one side of the third plane mirror 230 are disposed toward the second display screen 12. One side of the third plane mirror 230 away from the second plane mirror 220 and one side of the fourth plane mirror 240 are disposed toward the third display screen 13. One side of the first plane mirror 210 away from the second plane mirror 220 is a light exit side, and one side of the fourth plane mirror 240 away from the third plane mirror 230 is a light exit side.

The second plane mirror 220 includes a first light-transmitting plate 201 and a first optical film 301 disposed on one surface of the first light-transmitting plate 201. The first optical film 301 is used for reflecting emitted the first monochromatic color by the first display screen 11 and transmitting the second monochromatic color emitted by the second display screen 12.

The first plane mirror 210 includes a second light-transmitting plate 202 and a second optical film 302 disposed on one surface of the second light-transmitting plate 202. The second optical film 302 is used for reflecting the third monochromatic color emitted by the third display screen 13 and transmitting the first monochromatic color emitted by the first display screen 11 and the second monochromatic color emitted by the second display screen 12.

The fourth plane mirror 240 includes a third light-transmitting plate 203 and a third optical film 303 provided on one surface of the third light-transmitting plate 203. The third optical film 303 is used for reflecting the first monochromatic color emitted by the first display screen 11 and transmitting the second monochromatic color emitted by the second display screen 12 and the third monochromatic color emitted by the third display screen 13.

The third plane mirror 230 includes a fourth light-transmitting plate 204 and a fourth optical film 304 provided on one surface of the fourth light-transmitting plate 204. The fourth optical film 304 is used for reflecting the third monochromatic color emitted by the third display screen 13 and transmitting the second monochromatic color emitted by the second display screen 12.

It should be noted that the first optical film 301 can be disposed on one side of the first light-transmitting plate 201 facing the first plane mirror 210 or can also be disposed on one side of the first light-transmitting plate 201 facing the third plane mirror 230.

The second optical film 302 can be disposed on one side of the second light-transmitting plate 202 facing the second plane mirror 220 or can be disposed on one side of the second light-transmitting plate 202 facing the fourth plane mirror 240.

The third optical film 303 can be disposed on one side of the third light-transmitting plate 203 facing the first plane mirror 210 or can be disposed on one side of the third light-transmitting plate 203 facing the third plane mirror 230.

The fourth optical film 304 can be disposed on one side of the fourth light-transmitting plate 204 facing the fourth plane mirror 240 or can be disposed on one side of the fourth light-transmitting plate 204 facing the second plane mirror 220.

For example, materials of the first light-transmitting plate 201, the second light-transmitting plate 202, the third light-transmitting plate 203, and the fourth light-transmitting plate 204 can be glass or resin.

Referring to FIG. 4, the first plane mirror 210 and the third plane mirror 230 can be located on a straight line, and the second plane mirror 220 and the fourth plane mirror 240 can be located on another straight line. The two straight lines are perpendicular to each other. That is, among the first plane mirror 210, the second plane mirror 220, the third plane mirror 230, and the fourth plane mirror 240, any two adjacent plane mirrors are perpendicular to each other.

For example, a reflectivity of the first optical film 301 to the first monochromatic color is greater than a transmittance of the first optical film 301 to the first monochromatic color, and a transmittance of the first optical film 301 to the second monochromatic color is greater than a reflectivity of the first optical film 301 to the second monochromatic color.

A reflectivity of the second optical film 302 to the third monochromatic color is greater than a transmittance of the second optical film 302 to the third monochromatic color. A transmittance of the second optical film 302 to the first monochromatic color is greater than a reflectivity of the second optical film 302 to the first monochromatic color. A transmittance of the second optical film 302 to the second monochromatic color is greater than a reflectivity of the second optical film 302 to the second monochromatic color.

A reflectivity of the third optical film 303 to the first monochromatic color is greater than a transmittance of the third optical film 303 to the first monochromatic color. A transmittance of the third optical film 303 to the second monochromatic color is greater than a reflectivity of the third optical film 303 to the second monochromatic color. A transmittance of the third optical film 303 to the third monochromatic color is greater than a reflectivity of the third optical film 303 to the third monochromatic color.

A reflectivity of the fourth optical film 304 to the third monochromatic color is greater than a transmittance of the fourth optical film 304 to the third monochromatic color, and a transmittance of the fourth optical film 304 to the second monochromatic color is greater than a reflectivity of the fourth optical film 304 to the second monochromatic color.

In the embodiment of the present disclosure, the waveguide element 60 can be a diffractive optical waveguide (such as a holographic diffractive waveguide) or an array optical waveguide.

Please refer to FIG. 5. FIG. 5 illustrates a schematic structural diagram of a waveguide element provided by an embodiment of the present disclosure. When the waveguide element 60 is a diffractive optical waveguide, the waveguide element 60 can include a coupling-in region 61, a transfer region 62, and a coupling-out region 63. The coupling-in region 61 is used for receiving light transmitted from the projection lens 50, and the transfer region 62 is used for connecting the coupling-in region 61 and the coupling-out region 63. After the light emitted by the color combination device 20 enters the waveguide element 60, the light passes through the coupling-in region 61, the transfer region 62, and the coupling-out region 63 in sequence. Then, after passing through the coupling-out region 63, the light transmits to the user's eyes.

When the waveguide element 60 is the diffraction optical waveguide, a working principle of the waveguide element 60 can be as follows. The light emitted from the projection lens 50 is diffracted for the first time after entering the coupling-in region 61. The diffracted light is diffracted in the waveguide element 60 as follows. The light propagates by total reflection, and the second diffraction occurs after reaching the transfer region 62. The diffracted light propagates by total reflection in the waveguide element 60, and the third diffraction occurs after reaching the coupling-out region 63. After diffraction, of light is transmitted into the user's eyes.

For example, the waveguide element 60 can include a glass flat plate or a resin flat plate.

Please refer to FIG. 6 and FIG. 7. FIG. 6 illustrates a second structural schematic diagram of AR glasses provided by an embodiment of the present disclosure. FIG. 7 illustrates a third structural schematic diagram of AR glasses provided by an embodiment of the present disclosure. The coupling-in region 61 of the waveguide element 60 can be provided with a coupling-in grating 64. The coupling-in grating 64 can be provided on one side of the waveguide element 60 facing the projection lens 50 (as shown in FIG. 6) or on one side of the waveguide element 60 away from the projection lens 50 (as shown in FIG. 7).

It should be noted that when the coupling-in grating 64 is disposed on the side of the waveguide element 60 facing the projection lens 50, the coupling-in grating 64 can be a transmission grating. The transmission grating can diffract light and allow the diffracted light to pass through the transmission grating. That is, after the light emitted from the projection lens 50 enters the coupling-in grating 64, the light is diffracted, and the diffracted light passes through the coupling-in grating 64 to enter the inside of the waveguide element 60 for propagation.

When the coupling-in grating 64 is disposed on the side of the waveguide element 60 away from the projection lens 50, the coupling-in grating 64 can be a reflection grating. The reflection grating can diffract the light and reflect the diffracted light to the side where the incident light is located. That is, the light emitted from the projection lens 50 enters the coupling-in grating 64 after passing through the waveguide element 60 and is diffracted in the coupling-in grating 64. The diffracted light is reflected by the coupling-in grating 64 to the inside of the waveguide element 60 for propagation.

Please refer to FIG. 6 and FIG. 7. A center of the second display screen 12, a symmetry axis of the color combination device 20, a symmetry axis of the projection lens 50, and a center of the coupling-in grating 64 are located on the same straight line.

In the embodiment of the present disclosure, the projection lens 50 can play the role of imaging an image synthesized by the color combination device 20 and amplifying the image.

For example, the projection lens 50 can include multiple lenses 51. A number of the multiple lenses 51 can be 2 to 10. The multiple lenses 51 are arranged in sequence in a direction from the color combination device 20 to the waveguide element 60. In some embodiments, the number of multiple lenses 51 can be 2, 3, 4, 5, 6, 7, 8, 9, or 10. The multiple lenses 51 can be selected from one or more of biconcave lenses, plano-concave lenses, convex-concave lenses, biconvex lenses, and plano-convex lenses.

For example, the lenses 51 can be made of resin or glass.

Referring to FIG. 1, the waveguide element 60 and the projection lens 50 can be in a perpendicular relationship or a non-perpendicular relationship. For example, an angle between a plane where the waveguide element 60 is located and an extension direction of the projection lens 50 can be 75°˜105°, such as 75°, 80°, 85°, 90°, 95°, 100°, 105°, etc. It should be noted that the extension direction of the projection lens 50 refers to an arrangement direction of the multiple lenses 51 in the projection lens 50, that is, the direction from the color combination device 20 to the waveguide element 60.

In the embodiment of the present disclosure, when a reflectivity of a certain optical film layer or an optical film to a certain monochromatic color is greater than a transmittance, the reflectivity of the optical film layer or the optical film to the monochromatic color can be 60% to 100%, for example, 60%, 65%, 70%, 75%, 80%, 85%, 90%, 95%, 100%, etc. The transmittance of the optical film layer or the optical film for this monochromatic color can be 0˜40%, for example, 0, 15%, 20%, 25%, 30%, 35%, 40%, etc. When a transmittance of a certain optical film layer or an optical film to a certain monochromatic color is greater than a reflectivity, the transmittance of the optical film layer or the optical film to the monochromatic color can be 60% to 100%, for example, 60%, 65%, 70%, 75%, 80%, 85%, 90%, 95%, 100%, etc. The reflectivity of the optical film layer or the optical film for the monochromatic color can be 0˜40%, for example, 0, 15%, 20%, 25%, 30%, 35%, 40%, etc.

Please refer to FIG. 1 to FIG. 5. In conclusion, a working principle of the AR glasses 100 according to the embodiment of the present disclosure is as follows. The light emitted by the first display screen 11, the second display screen 12, and the third display screen 13 respectively propagates to the color combination device 20. The light emitted by the first display screen 11 and the third display screen 13 is reflected to the projection lens 50. The light from the second display screen 12 propagates to the projection lens 50 through the color combination device 20. Finally, the third display screen 11 is reflected to the projection lens 50. The light from the first display screen 11, the second display screen 12, and the third display screen 13 is merged and transmitted through the projection lens 50. The light enters the waveguide element 60 through the coupling-in region 61 of the waveguide element 60 and propagates to the transfer region 62 of the waveguide element 60. After reaching at the transfer region 62, a propagation direction changes and propagates to the coupling-out region 63. After reaching the coupling-out region 63, the propagation direction changes again. Finally, the light emits from the waveguide element 60, and finally the light enters the human eye. An image is formed on the retina of the human eye, so that the human eye can see an enlarged virtual image.

The AR glasses 100 provided by the embodiments of the present disclosure can adopt a small-size display screen, and the color combination device 20 and the projection lens 50 are both set to a smaller size to achieve a compact structure and small-volume display module. Coupled with optical waveguide technology, the AR glasses 100 that are close to the form of myopia glasses can be realized. The AR glasses 100 have outstanding advantages such as lightweight, low power consumption, and outdoor use.

The AR glasses provided by the embodiments of the present disclosure are introduced in detail above. The present disclosure uses specific examples to illustrate the principles and implementation methods of the present disclosure. The description of the above-mentioned embodiments is only used to help understand the present disclosure. At the same time, for those skilled in the art, there will be changes in the specific implementation and application scope based on the ideas of the present disclosure. In summary, the content of this description should not be understood as a limitation of the present application.

1. AR glasses, comprising:
a display device, the display device comprising multiple display screens, and the display screens used for emitting multiple different monochromatic colors;
a color combination device, the display screens respectively arranged around the color combination device, and the color combination device used for fusing the monochromatic colors emitted by the display screens to form an image;
a projection lens, disposed on one side of a light exit side of the color combination device; and
a waveguide element, disposed on one side of the projection lens away from the color combination device.

2. The AR glasses of claim 1, wherein the display device comprises a first display screen, a second display screen, and a third display screen, the first display screen is used for emitting a first monochromatic color, the second display screen is used for emitting a second monochromatic color, and the third display screen is used for emitting a third monochromatic color.

3. The AR glasses of claim 2, wherein the color combination device comprises a first prism, a second prism, a third prism, and a fourth prism, the first prism, the second prism, the third prism, and the fourth prism are all isosceles right-angle prisms;
vertices of the first prism, the second prism, the third prism, and the fourth prism are connected together, a bottom surface of the first prism is a light exit surface of the color combination device, a bottom surface of the second prism is disposed toward the first display screen, a bottom surface of the third prism is disposed toward the second display screen, and a bottom surface of the fourth prism is disposed toward the third display screen;
a first optical film layer is disposed between the third prism and the second prism, and the first optical film layer is used for reflecting the first monochromatic color emitted by the first display screen and transmitting the second monochromatic color emitted by the second display screen;
a second optical film layer is disposed between the second prism and the first prism, and the second optical film layer is used for reflecting the third monochromatic color emitted by the third display screen and transmitting the first monochromatic color emitted by the first display screen and the second monochromatic color emitted by the second display screen;
a third optical film layer is disposed between the first prism and the fourth prism, and the third optical film layer is used for reflecting the first monochromatic color emitted by the first display screen and transmitting the second monochromatic color emitted by the second display screen and the third monochromatic color emitted by the third display screen; and
a fourth optical film layer is disposed between the fourth prism and the third prism, and the fourth optical film layer is used for reflecting the third monochromatic color emitted by the third display screen and transmitting the second monochromatic color emitted by the second display screen.

4. The AR glasses of claim 3, wherein a reflectivity of the first optical film layer to the first monochromatic color is greater than a transmittance of the first optical film layer to the first monochromatic color, and a transmittance of the first optical film layer to the second monochromatic color is greater than a transmittance of the first optical film layer to the second monochromatic color;
a reflectivity of the second optical film layer to the third monochromatic color is greater than a transmittance of the second optical film layer to the third monochromatic color, a transmittance of the second optical film layer to the first monochromatic color is greater than a reflectivity of the second optical film layer to the first monochromatic color, and a transmittance of the second optical film layer to the second monochromatic color is greater than a reflectivity of the second optical film layer to the second monochromatic color;
a reflectivity of the third optical film layer to the first monochromatic color is greater than a transmittance of the third optical film layer to the first monochromatic color, a transmittance of the third optical film layer to the second monochromatic color is greater than a reflectivity of the third optical film layer to the second monochromatic color, and a transmittance of the third optical film layer to the third monochromatic color is greater than a reflectivity of the third optical film layer to the third monochromatic color; and
a reflectivity of the fourth optical film layer to the third monochromatic color is greater than a transmittance of the fourth optical film layer to the third monochromatic color, and a transmittance of the fourth optical film layer to the second monochromatic color is greater than a transmittance of the fourth optical film layer to the second monochromatic color.

5. The AR glasses of claim 3, wherein a first anti-reflection film is provided on the bottom surface of the second prism, and the first anti-reflection film is used for increasing the transmittance of the first monochromatic color;
a second anti-reflection film is provided on the bottom surface of the third prism, and the second anti-reflection film is used for increasing the transmittance of the second monochromatic color;
a third anti-reflection film is provided on the bottom surface of the fourth prism, and the third anti-reflection film is used for increasing the transmittance of the third monochromatic color; and
a fourth anti-reflection film is provided on the bottom surface of the first prism, and the fourth anti-reflection film is used for simultaneously increasing the transmittances of the first monochromatic color, the second monochromatic color, and the third monochromatic color.

6. The AR glasses of claim 2, wherein the color combination device comprise a first plane mirror, a second plane mirror, a third plane mirror, and a fourth plane mirror, and one end of the first plane mirror, one end of the second plane mirror, one end of the third plane mirror, and one end of the fourth plane mirror are connected together;
one side of the first plane mirror and one side of the second plane mirror are disposed toward the first display screen, one side of the second plane mirror away from the first plane mirror and one side of the third plane mirror are disposed toward the second display screen, one side of the third plane mirror away from the second plane mirror and one side of the fourth plane mirror are disposed toward the third display screen, one side of the first plane mirror away from the second plane mirror is a light exit side, and one side of the fourth plane mirror away from the third plane mirror is a light exit side;
the second plane mirror comprises a first light-transmitting plate and a first optical film disposed on one surface of the first light-transmitting plate, and the first optical film is used for reflecting emitted the first monochromatic color by the first display screen and transmitting the second monochromatic color emitted by the second display screen;
the first plane mirror comprises a second light-transmitting plate and a second optical film disposed on one surface of the second light-transmitting plate, and the second optical film is used for reflecting the third monochromatic color emitted by the third display screen and transmitting the first monochromatic color emitted by the first display screen and the second monochromatic color emitted by the second display screen;
the fourth plane mirror comprises a third light-transmitting plate and a third optical film provided on one surface of the third light-transmitting plate, and the third optical film is used for reflecting the first monochromatic color emitted by the first display screen and transmitting the second monochromatic color emitted by the second display screen and the third monochromatic color emitted by the third display screen; and
the third plane mirror comprises a fourth light-transmitting plate and a fourth optical film provided on one surface of the fourth light-transmitting plate, and the fourth optical film is used for reflecting the third monochromatic color emitted by the third display screen and transmitting the second monochromatic color emitted by the second display screen.

7. The AR glasses of claim 6, wherein a reflectivity of the first optical film to the first monochromatic color is greater than a transmittance of the first optical film to the first monochromatic color, and a transmittance of the first optical film to the second monochromatic color is greater than a reflectivity of the first optical film to the second monochromatic color;
a reflectivity of the second optical film to the third monochromatic color is greater than a transmittance of the second optical film to the third monochromatic color, a transmittance of the second optical film to the first monochromatic color is greater than a reflectivity of the second optical film to the first monochromatic color, and a transmittance of the second optical film to the second monochromatic color is greater than a reflectivity of the second optical film to the second monochromatic color;
a reflectivity of the third optical film to the first monochromatic color is greater than a transmittance of the third optical film to the first monochromatic color, a transmittance of the third optical film to the second monochromatic color is greater than a reflectivity of the third optical film to the second monochromatic color, and a transmittance of the third optical film to the third monochromatic color is greater than a reflectivity of the third optical film to the third monochromatic color; and
a reflectivity of the fourth optical film to the third monochromatic color is greater than a transmittance of the fourth optical film to the third monochromatic color, and a transmittance of the fourth optical film to the second monochromatic color is greater than a reflectivity of the fourth optical film to the second monochromatic color.

8. The AR glasses of claim 2, wherein the waveguide element comprise a coupling-in region, a transfer region, and a coupling-out region, the coupling-in region is used for receiving light transmitted from the projection lens, the transfer region is used for connecting the coupling-in region and the coupling-out region, and after the light emitted by the color combination device enters the waveguide element, the light passes through the coupling-in region, the transfer region, and the coupling-out region in sequence and then after passing through the coupling-out region, the light transmits to user's eyes.

9. The AR glasses of claim 8, wherein the coupling-in region of the waveguide element is provided with a coupling-in grating, and the coupling-in grating is provided on one side of the waveguide element facing the projection lens.

10. The AR glasses of claim 9, wherein a center of the second display screen, a symmetry axis of the color combination device, a symmetry axis of the projection lens, and a center of the coupling-in grating are located on the same straight line.

11. The AR glasses of claim 2, wherein the first display screen, the second display screen, and the third display screen are all Micro LED display screens.

12. The AR glasses of claim 2, wherein the first monochromatic color, the second monochromatic color, and the third monochromatic color are any combination of red light, green light, and blue light.

13. The AR glasses of claim 6, wherein materials of the first light-transmitting plate, the second light-transmitting plate, the third light-transmitting plate, and the fourth light-transmitting plate are glass or resin.

14. The AR glasses of claim 1, wherein the AR glasses comprises two lenses, nose braces, and two temples, the nose braces are arranged between the two lenses and connects the two lenses, the two temples are respectively disposed on one side of the two lenses away from the nose braces, the waveguide element is disposed at positions of the lenses, and the display device, the color combination device, and the projection lens are disposed at position of the temples or the nose braces.

15. The AR glasses of claim 1, wherein the waveguide element comprises a glass flat plate or a resin flat plate.

16. The AR glasses of claim 1, wherein the projection lens comprises multiple lenses, and a number of the multiple lenses is 2 to 10.

17. The AR glasses of claim 16, wherein the multiple lenses are selected from one or more of biconcave lenses, plano-concave lenses, convex-concave lenses, biconvex lenses, and plano-convex lenses.

18. (canceled)

19. The AR glasses of claim 1, wherein the waveguide element and the projection lens are in a perpendicular relationship or a non-perpendicular relationship.

20. The AR glasses of claim 1, wherein an angle between a plane where the waveguide element is located and an extension direction of the projection lens is 75°˜105°.

21. The AR glasses of claim 8, wherein the coupling-in region of the waveguide element is provided with a coupling-in grating, and the coupling-in grating is provided on one side of the waveguide element away from the projection lens.
